(19) United States
(12) Patent Application Publication
(10) Pub. No.: US 2022/0324364 A1
(43) Pub. Date: Oct. 13, 2022

(54) Seatback Pad Holder Apparatus

(71) Applicant: Eric Hill, Bakersfield, CA (US)

(72) Inventor: Eric Hill, Bakersfield, CA (US)

(21) Appl. No.: 17/225,181

(22) Filed: Apr. 8, 2021

(51) Int. Cl. B60N 3/00; B60R 7/04

(52) U.S. Cl. CPC B60N 3/004; B60R 7/043

(57) ABSTRACT

A seatback pad holder apparatus for storing dashboard foot pads and other items includes a rear panel having a rear top side, a rear bottom side, a rear front side, a rear back side, a rear left side, and a rear right side. A plurality of rest pads is coupled to the rear panel. Each rest pad is selectively removable and placed within the vehicle for user comfort. A front panel is coupled to the rear panel and selectively covers the rear front side. A pair of headrest mount straps is coupled to the rear panel. Each headrest mount strap is coupled to the rear top side and configured to engage a pair of posts of a headrest of the vehicle. A stability strap is coupled to the rear panel and extends from the rear left side to the rear right side to engage a seat back of the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

(1) Field of the Invention.

The disclosure relates to seatback holder devices and more particularly pertains to a new seatback holder device for storing dashboard foot pads and other items. The present device includes a plurality of straps and pockets to hold dashboard foot pads and other items. There is also a stabilizing strap to wrap around the seatback.

(2) Description of Related Art including information disclosed under 37 CFR 1.97 and 1.98.

The prior art relates to seatback holder devices. Known devices are typically intended to serve as table tops and drink holders. These devices lack dashboard foot pads and pockets to hold them. Known devices also lack a stabilizing strap to wrap around the chair back.

### BRIEF SUMMARY OF THE INVENTION

An embodiment of the disclosure meets the needs presented above by generally comprising a rear panel having a rear top side, a rear bottom side, a rear front side, a rear back side, a rear left side, and a rear right side. A plurality of rest pads is coupled to the rear panel. Each rest pad is selectively removable and configured to be placed within a vehicle for user comfort. A front panel is coupled to the rear panel. The front panel selectively covers the rear front side. A pair of headrest mount straps is coupled to the rear panel. Each headrest mount strap is coupled to the rear top side and configured to engage a pair of posts of a headrest of the vehicle. A stability strap is coupled to the rear panel. The stability strap extends from the rear left side to the rear right side and is configured to engage a seat back of the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a seatback pad holder apparatus according to an embodiment of the disclosure.

FIG. 2 is a front elevation view of an embodiment of the disclosure.

FIG. 3 is a rear elevation view of an embodiment of the disclosure.

FIG. 4 is a side elevation view of an embodiment of the disclosure.

FIG. 5 is an in-use view of an embodiment of the disclosure.

FIG. 6 is a top plan view of an embodiment of the disclosure.

FIG. 7 is an isometric view of an embodiment of the disclosure.

FIG. 8 is an isometric view of an embodiment of the disclosure.

### DETAILED DESCRIPTION OF THE INVENTION

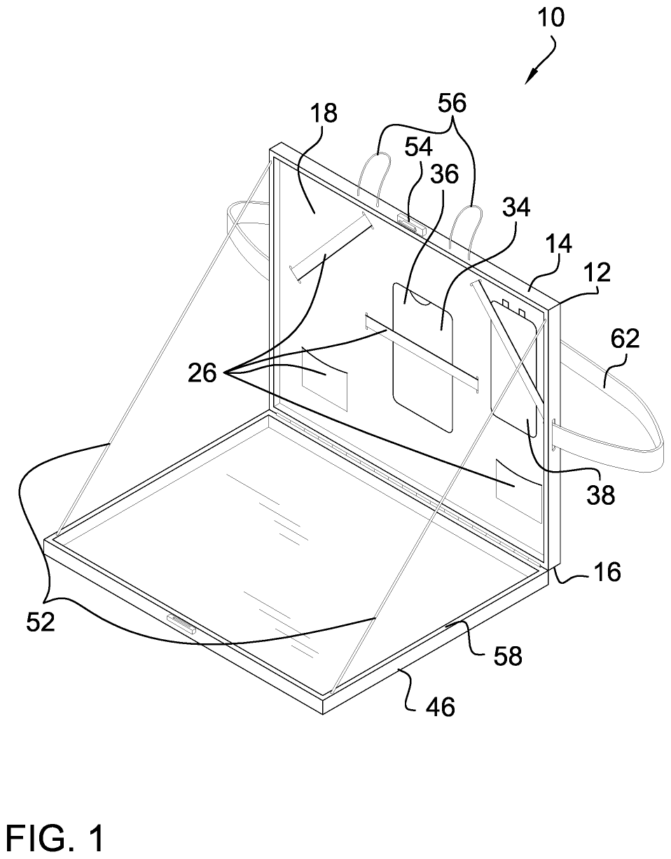

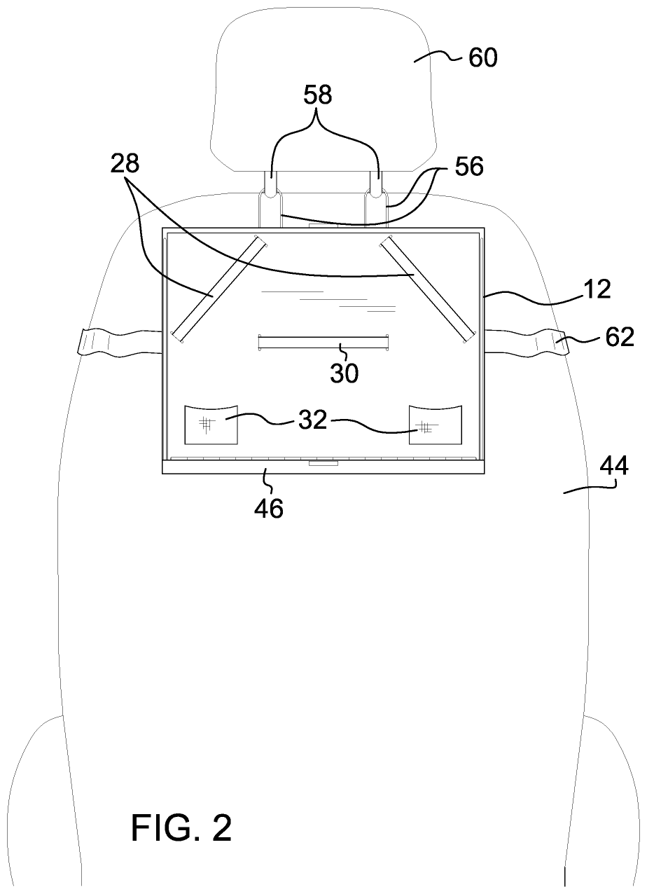

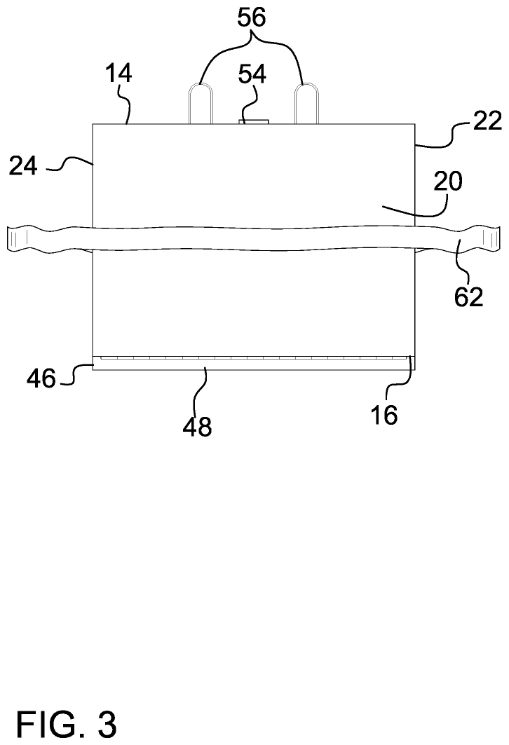

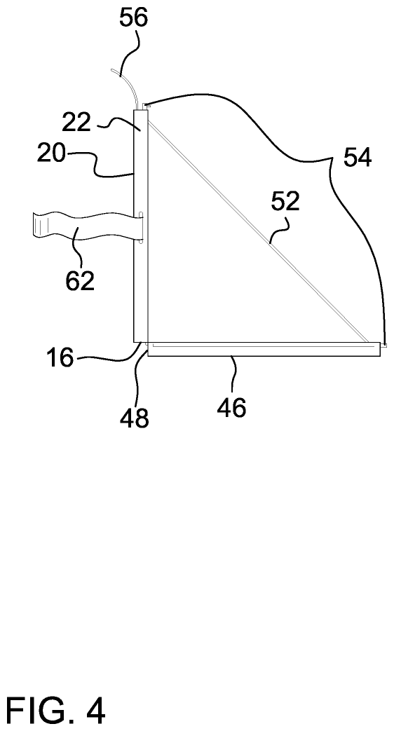

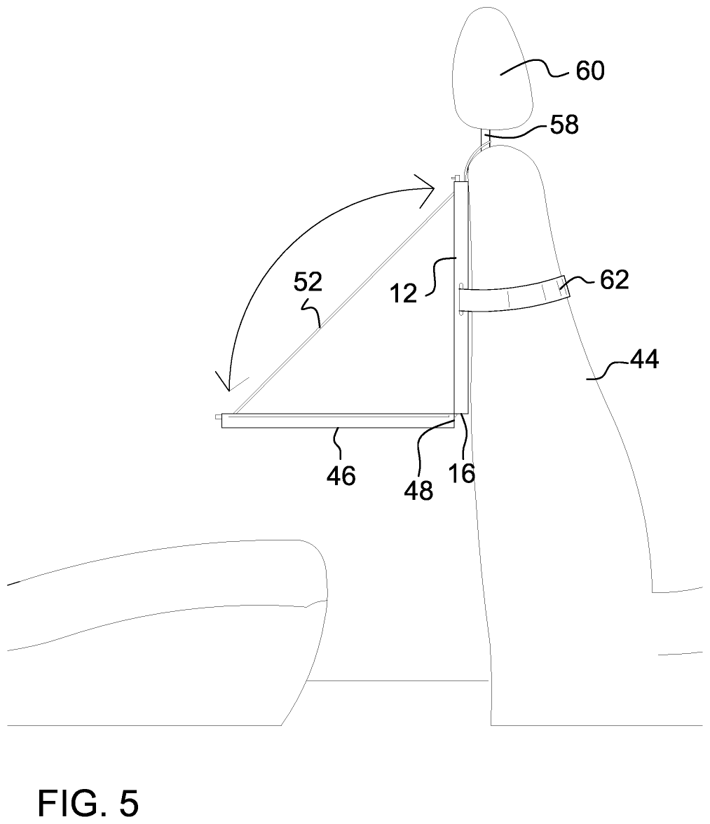

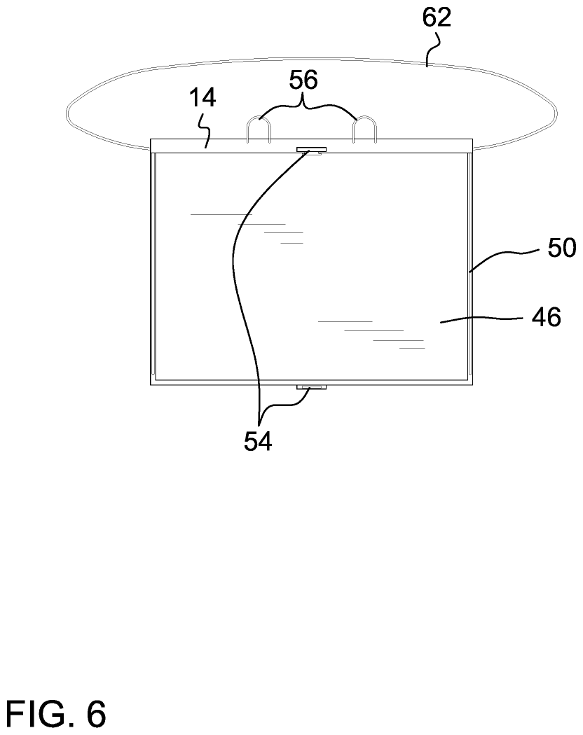

With reference now to the drawings, and in particular to FIGS. 1 through 8 thereof, a new seatback holder device embodying the principles and concepts of an embodiment of the disclosure and generally designated by the reference numeral 10 will be described.

As best illustrated in FIGS. 1 through 8, the seatback pad holder apparatus 10 generally comprises a rear panel 12 having a rear top side 14, a rear bottom side 16, a rear front side 18, a rear back side 20, a rear left side 22, and a rear right side 24. The rear front side 18 may have a plurality of elastic straps 26 including a pair of upper angled straps 28, a medial horizontal strap 30, and a pair of lower pocket straps 32. The pair of lower pocket straps 32 may be configured to secure a variety of items including, but not limited to, beverages, personal electronic devices, and the like.

A plurality of rest pads 34 is coupled to the rear panel 12. The plurality of elastic straps 24 may secure the plurality of rest pads 34. Each rest pad 34 is selectively removable and configured to be placed within a vehicle for user comfort. The plurality of rest pads 34 may include a dashboard pad 36 and a back seat pad 38. The dashboard pad 36 may be stored within the medial horizontal strap 30 and there may be two back seat pads 38 stored in the pair of upper angled straps 28. The dashboard pad 36 may have a semicircular pad handle 40 and the back seat pad 38 may have a pair of pad straps 42 configured to engage a seat back 44 of the vehicle.

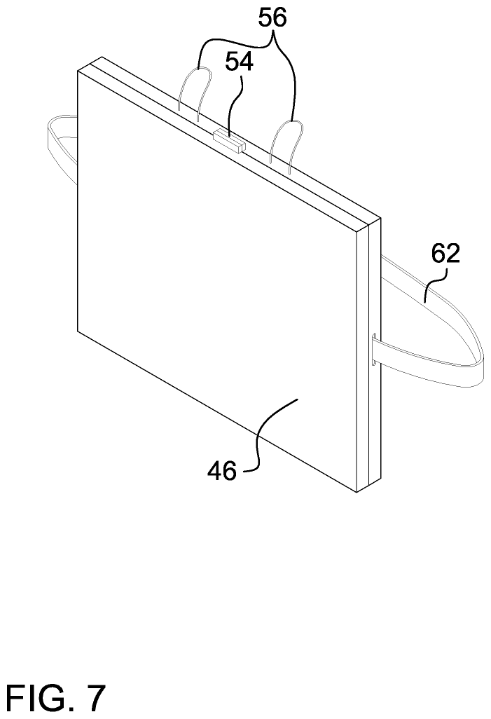

A front panel 46 is coupled to the rear panel 12. The front panel 46 selectively covers the rear front side 18. The front panel 46 has a front bottom side 48 pivotably coupled to the rear bottom side 16 and moves between a closed position parallel with the rear front side 18 (seen in FIG. 7) and an open position extending perpendicularly from the rear front side 18 (seen in FIGS. 1-6). A front perimeter 50 of the front panel 46 may be raised to contain items stored on the front panel 46.

A pair of gusset straps 52 may be coupled to the rear panel 12 and the front panel 46. The pair of gusset straps 52 secures the front panel 46 in the open position. A latch 54 is coupled to the rear panel 12 and the front panel 46. The latch 54 selectively secures the front panel 46 in the closed position.

A pair of headrest mount straps 56 is coupled to the rear panel 12. Each headrest mount strap 56 is coupled to the rear top side 14 and configured to engage a pair of posts 58 of a headrest 60 of the vehicle. Each headrest mount strap 56 may be looped. A stability strap 62 is coupled to the rear panel 12. The stability strap 62 extends from the rear left side 22 to the rear right side 24 and is configured to engage the seat back 44 of the vehicle.

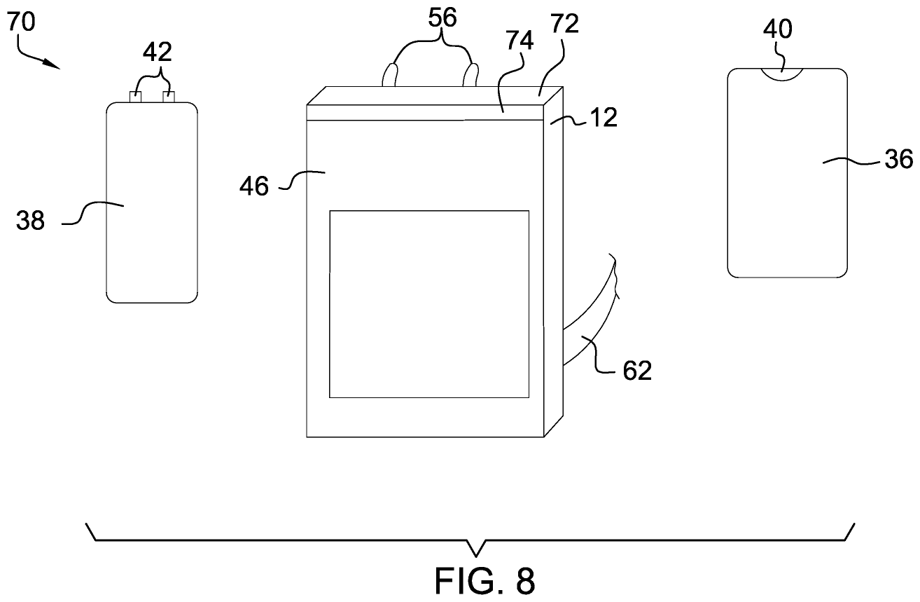

In an alternative embodiment 70 (shown in FIG. 8), the rear panel 12 has a first slot 72 to receive the dashboard pad 36 and the front panel 46 has a second slot 74 to receive the back seat pad 38.

In use, the pair of headrest mount straps 56 are engaged with the pair of posts 58 and the stability strap 62 is engaged with the seat back 44. The dashboard pad 36 is removed as desired and placed on the dashboard of the vehicle to serve as a more comfortable head or foot rest for the front passenger. The back seat pad 38 is used as desired in the back of the vehicle for the rear passengers. Other items may be stored and placed within the plurality of elastic straps 26 and on the front panel 46 in the open position.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A seatback pad holder apparatus comprising:
a rear panel having a rear top side, a rear bottom side, a rear front side, a rear back side, a rear left side, and a rear right side;
a plurality of rest pads coupled to the rear panel, each rest pad being selectively removable and configured to be placed within a vehicle for user comfort;
a front panel coupled to the rear panel, the front panel selectively covering the rear front side;
a pair of headrest mount straps coupled to the rear panel, each headrest mount strap being coupled to the rear top side and configured to engage a pair of posts of a headrest of the vehicle;
a stability strap coupled to the rear panel, the stability strap extending from the rear left side to the rear right side and being configured to engage a seat back of the vehicle;
the rear front side having a plurality of elastic straps, each elastic strap haying parallel longitudinal edges wherein each elastic strap is configured to extend across a respective one of the plurality of rest pads wherein the plurality of elastic straps are configured for securing the plurality of rest ails

2. The seatback pad holder apparatus of claim I further comprising the front panel having a front bottom side pivotably coupled to the rear bottom side and moving between a closed position parallel with the rear front side and an open position extending perpendicularly from the rear front side.

3. The seatback pad holder apparatus of claim 2 further comprising a pair of gusset straps coupled to the rear panel and the front panel, the pair of gusset straps securing the front panel in the open position.

4. The seatback pad holder apparatus of claim 2 further comprising a latch coupled to the rear panel and the front panel, the latch selectively securing the front panel in the closed position.

5. The seatback pad holder apparatus of claim 2 further comprising a front perimeter of the front panel being raised.

6. (canceled)

7. The seatback pad holder apparatus of claim 6 further comprising the plurality of elastic straps including a pair of upper angled straps, a medial horizontal strap, and a pair of lower pocket straps.

8. The seatback pad holder apparatus of claim I further comprising the plurality of rest pads including a dashboard pad and a back seat pad.

9. The seatback pad holder apparatus of claim 8 further comprising the rear panel having a first slot to receive the dashboard pad and the front panel having a second slot to receive the back seat pad.

10. A seatback pad holder apparatus comprising:
a rear panel having a rear top side, a rear bottom side, a rear front side, a rear back side, a rear left side, and a rear right side, the rear front side having a plurality of elastic straps including a pair of upper angled straps, a medial horizontal strap, and a pair of lower pocket straps;
a plurality of rest pads coupled to the rear panel, each elastic strap having parallel longitudinal edges wherein each elastic strap is configured to extend across a respective one of the plurality of rest pads wherein the plurality of elastic straps are configured for securing the plurality of rest pads, the plurality of elastic straps securing the plurality of rest pads, each rest pad being selectively removable and configured to be placed within the vehicle for user comfort, the plurality of rest pads including a dashboard pad and a back seat pad;
a front panel coupled to the rear panel, the front panel selectively covering the rear front side, the front panel having a front bottom side pivotably coupled to the rear bottom side and moving between a closed position parallel with the rear front side and an open position extending perpendicularly from the rear front side, a front perimeter of the front panel being raised;
a pair of gusset straps coupled to the rear panel and the front panel, the pair of gusset straps securing the front panel in the open position;
a latch coupled to the rear panel and the front panel, the latch selectively securing the front panel in the closed position;
a pair of headrest mount straps coupled to the rear panel, each headrest mount strap being coupled to the rear top side and configured to engage a pair of posts of a headrest of the vehicle; and
a stability strap coupled to the rear panel, the stability strap extending from the rear left side to the rear right side and being configured to engage a seat back of the vehicle,
